(19) United States
(12) Patent Application Publication
(10) Pub. No.: US 2008/0296224 A1
(43) Pub. Date: Dec. 4, 2008

(54) REVERSE OSMOSIS PUMP SYSTEM

(75) Inventors: James E. Cook, Anoka, MN (US); James E. Cook, II, Plymouth, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: PUMPTEC, INC., Anoka, MN (US)

(21) Appl. No.: 11/754,738

(22) Filed: May 29, 2007

(51) Int. Cl. C02F 1/44; B01D 21/30; B01D 27/10; C02F 9/00; C02F 3/02; B01D 29/88

(52) U.S. Cl. 210/637; 210/130; 210/136; 210/137; 210/195.1; 210/195.2; 210/99

(57) ABSTRACT

Reverse osmosis (RO) systems having efficiency enhancing features are disclosed. Included are RO systems having a RO module and a pumping system. A feed fluid line can introduce feed fluid into the pumping system, and the pumping system can increase the pressure of the feed and pass the pressurized feed to the RO module. Such RO systems can also have a recycle stream leading from a concentrate side of the RO module to the pumping system and a purified stream leading from a purified side of the RO module. In some cases, the pumping system can boost the pressure of both the feed fluid and the recycle stream, and the boosted fluids can be fed into the RO module. The pumping system can have first and second pumping chambers for the feed fluid and the recycled concentrate. These pumping chambers can be separate pumps, or they can be referred to as a single pumping system, for example a double-acting simplex plunger pump.

### FIELD

The present invention relates generally to the field of reverse osmosis processes. More specifically, the present invention relates to systems and methods for enhancing the efficiency of reverse osmosis processes.

### BACKGROUND

Reverse osmosis (RO) processes can be employed to remove contaminants from water. RO systems can be used in a wide variety of applications, such as production of drinking water or removing hardness from water or other such fluids to prevent scaling, among other applications. RO systems can be used in applications where clean water is scarce, such as facilities in remote locations or in mobile applications such as emergency vehicles, recreational vehicles, military vehicles and marine applications, among other uses.

In many of these applications, the efficiency of RO systems is an ongoing challenge. This can be especially true for applications in which the supply of energy or feed water is limited. For example, when RO systems are used in remote locations or mobile applications, the supply of power and/or feed water can be limited. The efficiency of an RO system can be measured in many ways, including the amount of energy required to purify a given amount of water, or alternatively, the amount of purified water obtained from a given amount of unpurified water fed into the system.

RO systems can comprise a RO module and a pumping system. The pumping system can supply pressurized fluid to the RO module, and the RO module typically has a RO membrane. In some applications, water molecules can pass through the RO membrane and, depending on what type of membrane is used, certain molecules, ions, atoms or other undesirable contaminants can be prevented from passing through the membrane. This yields a purified water stream from a purified side of the RO membrane and a concentrate stream from a concentrate side of the RO membrane.

In RO systems, the osmotic pressure (often referred to as the normal osmotic pressure) is the applied pressure required to prevent the flow of a water across a membrane which separates solutions of different concentrations. The water entering a RO module can be introduced at a pressure greater than the osmotic pressure. This elevated pressure can facilitate water crossing the membrane while certain contaminants can be partially or completely prevented from crossing the membrane. Thus, RO systems typically require energy to boost the pressure of the feed water above the osmotic pressure. Many RO systems also exhaust water from the system in order to prevent the build-up of excessive concentrations of impurities on the concentrated side of the membrane. Thus, the amount of feed water required can be significantly greater than the amount of purified water produced. Both the amount of energy and the amount of feed water required to produce an amount of purified water is an ongoing concern.

### BRIEF SUMMARY

The present invention is related to the purification of water using RO systems, including systems which have improved efficiency, for example improved efficiency with respect to energy consumption and/or feed fluid requirements.

In one illustrative embodiment, a RO system is provided that includes a RO module and a pump system. A first inlet port of the pump system can be fluidly connected to a feed fluid stream (e.g. water), and an outlet port of the pump system can be fluidly connected to an inlet port of the RO module. The RO system can also have an outlet port on the concentrate side of the RO module for exhausting concentrate and an outlet stream on the purified side of the RO membrane for exhausting purified fluid. The concentrate outlet port can be fluidly connected to a second inlet port of the pump system, creating a recycle stream. In some cases, this recycle stream can be a closed loop, conserving a portion or substantially all of the pressure of the water exhausted from the concentrate side of the RO module. The pump system can be configured to receive both the feed stream and the recycle stream, and raise these two streams to a predetermined pressure for introduction into the RO module. Further, the closed-loop recycle stream can have an exhaust line for exhausting a portion of the recycled concentrate. Exhausting a portion of this concentrate stream can help maintain an acceptable concentration of impurities on the concentrate side of the membrane. In a further embodiment, a valve can be placed in the exhaust line to regulate the volume of the recycle concentrate that is exhausted from the system.

In another illustrative embodiment, an RO system can have an RO module and a pump system, where the pump system comprises two pumps. A first pump can be configured to receive a feed water stream and a second pump can be configured to receive a recycle stream from the concentrate side of the RO module. Each pump can have a pumping chamber. The respective streams can enter the pumping chambers at relatively lower pressures and leave the pumping chambers at relatively higher pressures. In some cases, a positive displacement pumping member can be disposed in these pumping chambers. In one embodiment, the chambers can be adjacent one another and a single positive displacement pumping member can act on both chambers. In such a case the chambers and the single positive displacement pumping member can be referred to as two pumps or, alternatively, can be collectively referred to as a double acting pump, for example a double acting simplex positive displacement pump. Other examples of the pump could be a double acting simplex plunger pump or a double acting simplex piston pump.

Efficiency of the RO system can be measured based on the amount of feed fluid that is required to produce a certain volume of purified fluid. Efficiency can also be described in terms of the amount of energy required to produce a certain volume of purified fluid.

In yet another embodiment of the invention, a method for purifying fluid with a RO system is provided that includes the step of providing feed fluid to the inlet of a first pump. The method can also include the step of providing a recycle stream from a concentrate outlet of a RO module to an inlet of a second pump. The method can comprise a step of using the first pump to boost the pressure of the feed fluid and the method can further comprise the step of using the second pump to boost the pressure of the recycle stream. In an optional additional step, the two streams with boosted pressures can be mixed together and the method can also comprise the step of providing the two streams to the inlet of the RO module. The two pumps in this method can also be configured such that they can be referred to as one double acting positive displacement pump, for example a simplex double acting plunger pump or a simplex double acting piston pump.

### BRIEF DESCRIPTION OF THE DRAWINGS

FIG. 1 is a schematic of an illustrative RO system;

FIG. 2 is a schematic of another embodiment of a RO system

FIG. 3 is a schematic of an embodiment of a pump system;

FIG. 4 is a cross-section of an embodiment of a plunger pump system;

FIG. 5 is a cross-section of another embodiment of a plunger pump system;

FIG. 6 is a cross-section of an embodiment of a piston pump; and

FIG. 7 is a cross-section of an embodiment of a duplex plunger pump system.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

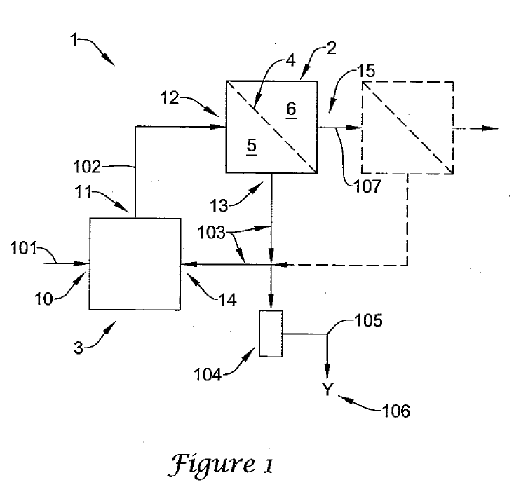

Referring now to FIG. 1, an illustrative embodiment of a RO system l is provided. The RO system 1 can have a RO module 2 and a pump system 3. The RO module 2 can have a RO membrane 4, which can separate the RO module into a concentrate side 5 and a purified side 6. The concentrate side can have a RO inlet 12 and a concentrate outlet 13. The purified side can have a purified outlet 15.

The pump system 3 can have a feed fluid inlet 10, a recycle inlet 14 and a pressurized fluid outlet 11. The feed fluid inlet 10 can connect to a feed fluid stream 101 such as a water stream, the recycle inlet 14 can connect to a recycle stream 103, and a pressurized fluid stream 102 can fluidly connect the pressurized fluid outlet 11 to the RO water inlet 12 of the RO module 2. In some embodiments, the pump system 3 can have two pumping chambers. In such cases, the pressurized fluid stream 102 can comprise two conduits, one running from an exit of each of the pumping chambers, and delivering the fluid to the RO module. Also, the two conduits of the pressurized water stream 102 could later be joined into a single conduit, which can lead to the RO module 2.

It is also contemplated that the fluid streams (for example, fluid streams 101, 102, 103) can have other structures or modules disposed in them. As an example, the feed stream 101 and/or the pressurized fluid stream 102 can have a filter placed in it, for example a media filter, a screen filter or any other type of filter that can remove particulate matter and/or other undesirable substances from the water stream. It is also contemplated that one or more of the fluid streams (for example, 101, 102, 103, 107) can have a water sanitization system, such as an ozone treatment module, placed in the line in order to kill any undesired organisms in the fluid such as viruses or bacteria.

In the illustrative embodiment of FIG. 1, the recycle stream 103 connects the concentrate outlet 13 to the recycle inlet 14 on the pump system 3. This recycle stream 103 can form a closed loop system that can preserve the pressure (and thus the energy) of the fluids in the recycle stream 103 as the fluids are communicated from the concentrate outlet 13 to the recycle inlet 14.

Further, in some embodiments, the recycle stream 103 can be split into two fluid pathways, with a first fluid pathway allowing the recycle stream 103 to continue on to the pump system and a second fluid pathway leading to an effluent stream 105. A valve 104 can be disposed in the effluent stream 105. The effluent stream can lead to a drain or storage container 106. The valve 104 can be a pressure regulating bypass valve. In such a case, the valve can release an amount of concentrate from the recycle stream 103 into the drain 106 in order to maintain a certain pressure in the recycle stream 103. In some cases, maintaining a constant pressure throughout the RO system 1 can be desirable if avoiding changes in pressure in the RO system is desirable, especially across the RO membrane 4. In other embodiments, the flow of the effluent stream 105 can be controlled using a flow set-point rather than the pressure set-point. In such cases, other types of valves could be used, such as needle valves, ball valves, gate valves, or other flow-control valves known in the art. In some cases, a controller (not shown) may be provided to actively or periodically change the flow of the effluent stream 105. For example, in cases of a higher temporary demand for purified water, the flow of the effluent stream 105 may be reduced. Likewise, during periods of lower demand for purified water, the flow of the effluent stream may be increased to flush the system of any excessive concentrate.

When a RO system has an exhaust line, for example exhaust line 106 of FIG. 1, the fluids exiting the exhaust line can be under pressure, and can therefore have energy that can possibly be captured. In such a case, it is contemplated that the energy (for example, energy in the form of pressure) of the stream can be captured using any of the known methods in the art. For example, the exhaust line can be passed through a turbine or other device that can capture the energy of the exhaust stream. The energy can then be used, for example to assist in driving a pumping system of the RO system and/or for recharging a battery or other such power supply used to drive one or more components of the RO system 1. In certain embodiments, for example, the RO system may include an energy recovery system for converting fluid pressure from the exhaust stream into electrical energy that can be used to charge a battery pack used to power the RO system.

In addition, the purified water stream 15 can be run through additional banks of RO modules. In these modules, a fluid stream running from the concentrate side of the membrane can be connected with the recycle stream 103 and the purified stream can contain purified fluid that can in some cases be run through additional banks of RO modules. In FIG. 1, a second RO module bank is shown in phantom. The RO system can have, for example, 1, 2, 3, 4 or more banks of RO modules.

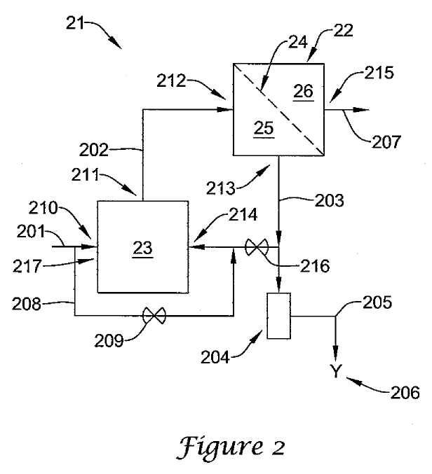

Turning now to FIG. 2, a schematic view of an alternate RO system is shown. The RO system of FIG. 2 is similar in most respects to FIG. 1, with like reference numerals indicating like structure. In FIG. 2, the feed water line 201 can have a split in it, creating a first portion of the feed line 217 and a second portion of the feed line 208. The first portion 217 can be connected to an inlet 210 of the pump system 23. The second portion 208 can either be connected directly to an inlet port of the pump system 23 (such as the second inlet 214 or a third inlet, which is not shown in FIG. 2) or, as shown, it can be joined with the recycle stream 203. Further, the recycle stream can have a recycle valve 216 for restricting or turning off the flow of fluids through the recycle stream 203. Also, the second portion 208 can have a second feed line valve 209 for restricting or turning off the flow of fluids through the second portion 208. In such a system, feed water can be fed into multiple pumps (or multiple sides of a single pump), allowing the recycle stream 203 to be supplemented with feed fluid. It is also contemplated that the recycle stream can be turned off using valve 216 and feed fluid fed into multiple pumps (or multiple sides of a single pump) of the pumping system 23. In this way, only fresh feed fluid can enter the system, for example when it is desired to flush the system.

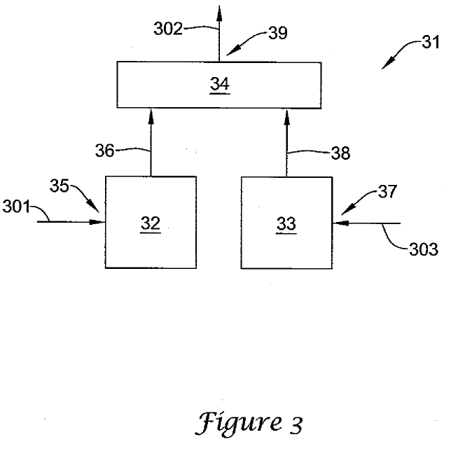

FIG. 3 shows a schematic view of an illustrative pump system 31. In this embodiment, the pump system 31 comprises a first pump 32 and a second pump 33. The first pump 32 can have an inlet port 35 that is fluidly connected to a feed fluid stream 301. The first pump can also have an outlet port 36. The second pump 33 can have an inlet port 37 that is fluidly connected to another fluid stream, for example recycle stream 303. The second pump 33 can also have an outlet port 38. The first and second pumps (32, 33) can receive fluid through their respective inlet ports (35, 37) at relatively low pressures and exhaust fluid through their respective outlet ports (36, 38) at relatively high pressures. The streams exiting the first and second pumps (32, 33) can then be combined in vessel 34, and an exit port 39 from the vessel 34 can be connected to a pressurized fluid line 302 that can lead to a RO module.

In some embodiments, the system can comprise conduits that fluidly connect the exit ports (36, 38) to the vessel 34, and the pressurized fluid line 302 can then further extend from the vessel exit port 39 to a RO module. Alternatively, the exit ports (36, 38) can open directly into the vessel 34, and the pressurized fluid line 302 can then extend from the vessel exit port 39 to a RO module. In yet another alternative, it is contemplated that pressurized fluid line 302 can comprise multiple conduits that lead from the exit ports (36, 38). These conduits can be joined downstream into one conduit, which can then lead to a RO module. Such an embodiment can have a vessel 34 disposed in the pressurized fluid line 302 after the conduits are joined, for example for prevention or mitigation of pressure variation in the fluid being supplied to the RO module.

In the illustrative embodiment shown in FIG. 3, the pumps (32, 33) can comprise any of a variety of pumps. In one embodiment, the pumps are both positive displacement pumps. In another embodiment, the positive displacement pumps could be a piston pump, a plunger pump, a diaphragm pump, a centrifugal pump, a scroll pump, or any other type of pump, as desired. It is contemplated that the pumps (32, 33) can be the same type of pump, or they can be two different types of pumps. The pumps can be disposed in separate housings, or, alternatively, the pumps can be disposed in a common housing.

In some cases, the inlet and outlet ports (35, 36, 37, 38) of the pumps (32, 33) can include check valves. For example, the inlet ports (35, 37) of the pumps (32, 33) can have check valves that partially or totally limit the flow of fluids to a direction entering the pumps (32, 33). Outlet ports (36, 38) can have check valves that partially or totally limit the flow of fluids to a direction exiting the pumps (32, 33).

It is contemplated that any of the embodiments of pumping systems described with respect to FIG. 3 can be incorporated into the RO systems of FIG. 1 and FIG. 2 as the pump system (3, 23).

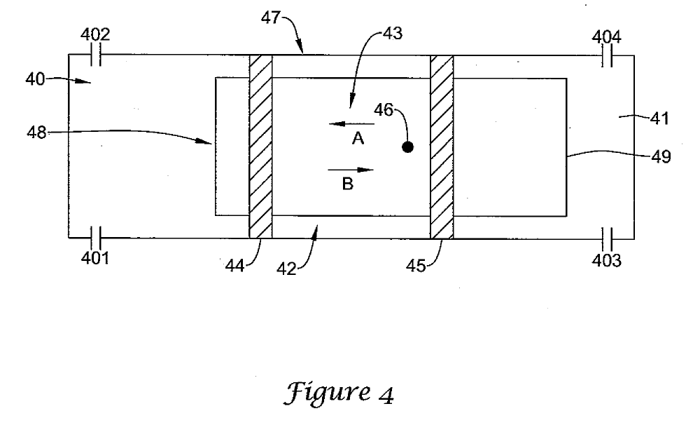

In the example of FIG. 3, the two pumps can be disposed in separate housings, or, alternatively, the two pumps can be disposed in a common housing. One example of two pumps that are shown in a common housing is shown in FIG. 4. The housing 47 of FIG. 4 is split into three chambers (40, 41, 42) by walls (44, 45). The first chamber 40 can be a first pumping chamber, and the second chamber 41 can be a second pumping chamber. The pumping chambers (40, 41) can be the portion of the pump in which the relatively low pressure fluid enters, is acted upon by a pumping mechanism, and is discharged at a relatively high pressure. For example, pumping chamber 40 can have an inlet port 401, which can be connected to a feed fluid stream. The second pumping chamber 41 can also have an inlet port 403, which can be connected to a recycle stream. These inlet ports (401, 403) can include check valves that substantially or totally limit the flow of fluids to a direction entering the pumping chambers. In addition, both pumping chambers can have outlet ports (402, 404). These outlet ports (402, 404) can also have check valves that substantially or totally limit the flow of fluids to a direction exiting the pumping chambers.

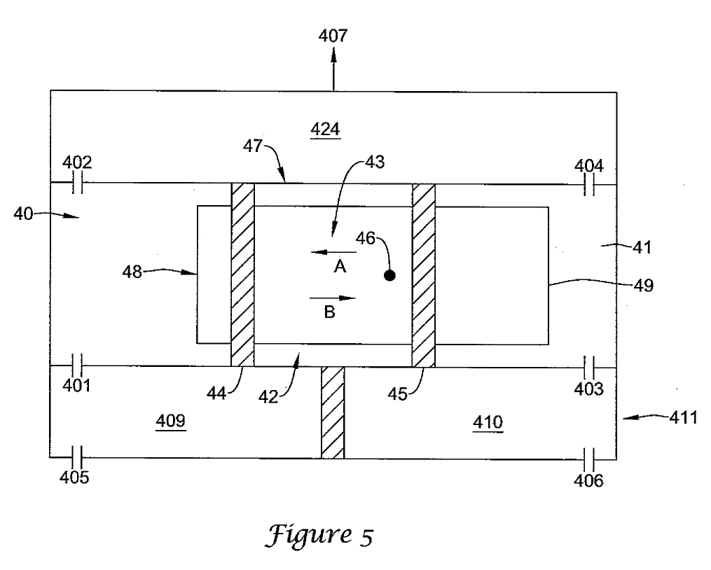

Turning to FIG. 5, the pump housing of FIG. 4 is shown with several optional additional features. In the embodiment shown in FIG. 5, the outlet ports (402, 404) can open directly into a vessel 424. In some embodiments, the vessel 424 can be integral with the pump housing 47, and in other embodiments the vessel 424 can be removably secured to, or it can be separate from, the pump housing 47. As another possible embodiment, conduits can run from the outlet ports (402, 404) to inlet ports on the vessel 424, and the pressurized fluid line 407 can then continue on to an RO module. In such a case, the vessel 424 can be integral with the pump housing 47, and in other embodiments the vessel 424 can be removably secured to, or it can be separate from, the pump housing 47. Further, in another embodiment, the pump system can be without a vessel 424, and the pressurized fluid line 407 can comprise conduits that are connected to the outlet ports (402, 404). The conduits can join downstream to form one conduit that can communicate fluid from the pump system to the RO module. A vessel such as vessel 424 can also be placed in the pressurized fluid line 407 downstream of the joining of the conduits.

In some cases, for example as shown in FIG. 5, the pump system can comprise a manifold 411. The manifold 411 can define a first inlet sub-chamber 409 and a second inlet sub-chamber 410. These first and second inlet sub-chambers (409, 410) can be fluidly connected to the first and second pumping chambers (40, 41), respectively, through the inlet ports (401, 403) of the first and second pumping chambers. The first and second inlet sub-chambers can have first and second inlet ports (405, 406). The first inlet port 405 can be connected to a feed fluid stream and the second inlet port 406 can be connected to a recycle stream. Similar to the inlet ports (401, 403), the inlet ports (405, 406) can have check valves that substantially or totally limit the flow of fluid to a direction entering the sub-chambers (409, 410).

In some cases, the manifold 411 can be removably secured to, or it can be separate from, the pump housing 47. In other cases, the manifold 411 can be integral with the pump housing 47. Further, in some cases, both the vessel 424 and the manifold 411 can be integral with the pump housing 47, they can both be removably secured to the pump housing 47, or they can both be separate from the pump housing 47.

In the illustrative embodiments of FIGS. 3 and 4, a positive displacement pumping mechanism 43 can be disposed within the pump housing 47. In one example, this positive displacement pumping mechanism 43 can be a plunger. In some embodiments, the pumping housing 47 can have a first wall 44 that defines the first pumping chamber 40. The pumping housing 47 can also have a second wall 45 that defines the second pumping chamber 41. The positive displacement pumping mechanism 43 can have two ends, a first end 48 that can extend into the first pumping chamber 40 and a second end 49 that can extend into the second pumping chamber 41. In some embodiments such as FIG. 4, the first pumping chamber 40 and the first end 48 of the positive displacement pumping mechanism 43 can make up a first pump, and the second pumping chamber 41 and the second end 49 of the positive displacement pumping mechanism 43 can make up a second pump.

As shown in the embodiment of FIG. 4, the pump housing 47 can also have a central chamber 42. This central chamber 42 can be defined by walls (44, 45). A drive mechanism (not shown) can be disposed in this central chamber 42. It is also contemplated that a drive mechanism can be located outside the central chamber 42 and a drive member can extend from outside to inside the central chamber 42 to drive the pumping system. One example of a drive that can be used to drive the positive displacement mechanism 43 through its pumping cycle is a cam system. The drive mechanism can, for example, attach to the positive displacement pumping mechanism 43 at drive point 46, and can move the positive displacement pumping mechanism 43 through a pumping motion. For example, as the positive displacement pumping mechanism 43 is moved in the direction of arrow “A” in FIG. 4, the pressure in chamber 40 can be increased, forcing fluids out of chamber 40. At the same time, the pressure in chamber 41 can be decreased, which can draw fluids into the chamber 41. Similarly, if the positive displacement pumping mechanism 43 is moved in the direction of arrow “B”, then fluids can be drawn into chamber 40 and can be exhausted from chamber 41. In some embodiments, the pressure of the fluids entering one side of the pump can lower the energy required by the pump to exhaust fluids from the other side of the pump.

In some cases where the positive displacement pumping mechanism 43 acts on both the first and second pumping chambers (40, 41), as shown in FIG. 4, the positive displacement pumping mechanism 43 and the chambers can also be collectively referred to as a double acting simplex pump. As shown in the embodiment of FIG. 4 where the positive displacement pumping mechanism 43 is a plunger, the plunger and the first and second pumping chambers (40, 41) can be collectively referred to as a double-acting simplex plunger pump.

It is contemplated that any of the embodiments described with respect to FIGS. 4 and 5 can be included as the pumping system (3, 23) in the RO systems shown in FIG. 1 and FIG. 2.

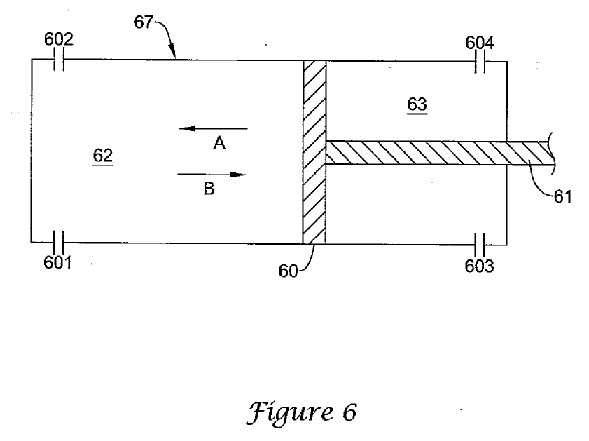

In addition to a plunger-type pump being used in the pumping system, several other types of pumps can be used in the pumping system in accordance with this invention. As one example, FIG. 6 shows a piston 60 disposed in a pumping housing 67. The piston can be connected to a rod 61. The piston 60 can be driven via movement in the rod 61. Movement in the rod 61 can be caused by an electric motor or by other means known in the art. The piston 60 effectively splits the pumping housing 67 into a first pumping chamber 62 and a second pumping chamber 63. The pumping chambers (62, 63) can have an inlet ports (601, 603) and outlet ports (602, 604). The inlet ports (601, 603) can include check valves that partially or entirely limit flow to a direction entering the chambers (62, 63). The outlet ports (602, 604) can include check valves that partially or entirely limit flow to a direction exiting the chambers (62, 63).

In the embodiment of FIG. 6, when the piston 60 moves in the direction indicated by arrow “A”, fluids in the first chamber 62 can become pressurized, which can cause pressurized fluids to exit through the outlet port 602, and the pressure in the second chamber 63 can be reduced, causing fluids to enter the second chamber 63 through the inlet port 603. In addition, when the piston 60 moves in the direction of arrow “B”, fluids in the second chamber 63 can become pressurized, which can cause the fluids to exit through the outlet port 604, and the pressure in the first chamber 62 can be reduced, causing fluid to enter the first chamber 62 through inlet port 601. Further, in some embodiments, the pressure of the fluid entering one of the pumping chambers can effectively lower the energy required by the pump to pressurize a fluid in the other pumping chamber.

In an embodiment such as FIG. 6, the piston 60 along with the first pumping chamber 62 can be referred to as a first pump and the piston 60 along with the second pumping chamber 63 can be referred to as a second pump. Further, the combination of the piston 60 and the first and second pumping chambers can also be referred to as a single pump, for example a double-acting simplex piston pump.

As with the pump system shown in FIG. 5, the pump system of FIG. 6 can optionally include a manifold. The manifold can be incorporated into the pump system of FIG. 6 in any of the forms or configurations discussed with respect to FIG. 5 above. The pump system can also include a vessel, similar to the vessel 424 of FIG. 5. The vessel can be incorporated into the pump system of FIG. 6 in any of the forms or configurations discussed with respect to FIG. 5. Alternatively, the system can have a pressurized fluid line comprising conduits connected to the outlet ports (602, 604), and the conduits can join to form one conduit fluidly communicating pressurized fluid to the RO module.

It is contemplated that any of the embodiments described with respect to FIG. 6 can be included as the pumping system (3, 23) in the RO systems shown in FIG. I and FIG. 2.

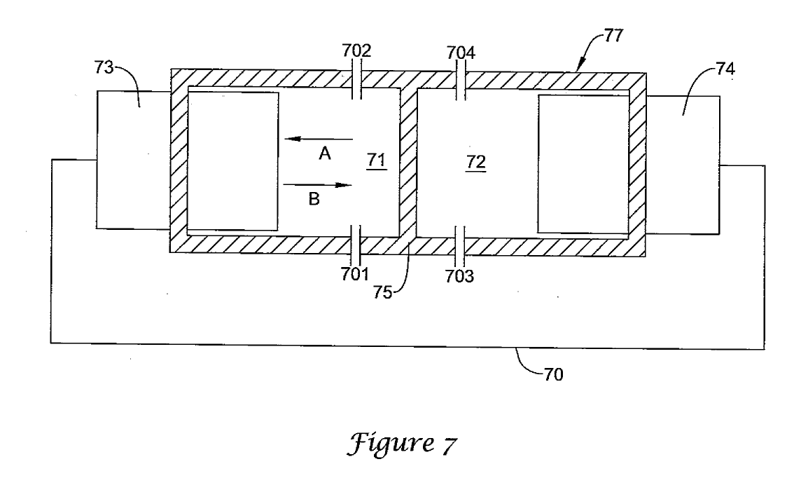

Turning now to FIG. 7, another embodiment of a pumping system of the current invention is illustrated. In this embodiment, the pumping system comprises a pumping housing 77. A wall 75 within the pumping housing 77 can separate a first pumping chamber 71 from a second pumping chamber 72. Each pumping chamber can have an inlet port (701, 703) and an outlet port (702, 704). Additionally, the inlet ports (701, 703) can include check valves that partially or entirely limit flow in a direction entering the chambers (71, 72). The outlet ports (702, 704) can also include check valves that partially or entirely limit flow in a direction exiting the chambers (71, 72).

As with the pump system shown in FIG. 5, the pump system of FIG. 7 can optionally include a manifold. The manifold can be incorporated into the pump system of FIG. 7 in any of the forms or configurations discussed with respect to FIG. 5. The pump system can also include a vessel, similar to the vessel 424 of FIG. 5. The vessel can be incorporated into the pump system of FIG. 7 in any of the forms or configurations discussed with respect to FIG. 5. Alternatively, the system can have a pressurized water line comprising conduits connected to the outlet ports (702, 704), and the conduits can join to form one conduit fluidly communicating pressurized fluid to the RO module.

In this embodiment, a first positive displacement pumping mechanism can be disposed in the first pumping chamber 71. For example, the first positive displacement pumping mechanism can be a first plunger 73. A second positive displacement pumping mechanism can be disposed in the second pumping chamber 72. For example, the second positive displacement pumping mechanism can be a second plunger 74.

The first and second plungers (73, 74) can be connected to one or more drives. The one or more drives can move the plungers (73, 74) through a pumping motion. For example, when a drive moves the first plunger 73 in the direction of arrow “A”, the pressure can be increased in the first chamber 71, forcing fluids out of the first chamber 71. When a drive moves the first plunger 73 in the direction of arrow “B”, the pressure in the first chamber 71 can be decreased, which can draw fluids into the first chamber 71. Similarly, the second plunger moving in the direction of arrow “A” can lower the pressure in the second chamber 72, which can force fluids out of the second chamber 72. Further, moving the second plunger in the direction of arrow “B” can increase the pressure in the second chamber 72, which can draw fluids into the second chamber 72.

The plungers can each have their own drive mechanism, which can be any drive mechanism known in the art, such as an electric motor. Also, as shown in the illustrative embodiment of FIG. 7, the plungers (73, 74) can be connected using a yoke 70, which can allow for one drive to be used in driving both of the plungers (73, 74). In such a case, the movement of the plungers (73, 74) through the pumping motion can be coordinated, with the pressure being increased in the first chamber 71 while the pressure is decreased in the second chamber 72, and vice versa. If the motion of the plungers (73, 74) is coordinated, the fluid entering one pumping chamber can lower the energy required to pressurize the other pumping chamber. With multiple positive displacement pumping mechanisms, such a system can be referred to as a duplex pump. In cases where the plungers (73, 74) have a single drive mechanism connecting the plungers, the system can be referred to as a double acting duplex pump, for example a double acting duplex plunger pump.

It is contemplated that any of the embodiments described with respect to FIG. 7 can be included as the pumping system (3, 23) in the RO systems shown in FIG. 1 and FIG. 2. In another example embodiment of the invention, any of the RO systems described above can be used in a system for producing drinking and/or purified general use water. Such systems can be incorporated into a vehicle, for example a recreational vehicle (RV) or camper, an emergency vehicle (fire engine, ambulance, or emergency aircraft, for example), a military vehicle, or other vehicles where water purification may be desired. In addition, another example of a use for any of the above systems could be in marine applications.

In some embodiments, the systems can be incorporated into portable units that can be battery powered and/or powered from an existing electrical grid, and can be used in locations where purified water is relatively scarce. In some cases, the relatively low amount of energy required to run the RO systems described herein can facilitate the use of solar power to run the RO system.

In another example embodiment, any of the systems described above can be used to purify water for cleaning systems or other systems where impurities can affect the operation. For example, in clothes, window, or car cleaning operations, metal ions or other materials in the water can cause staining or allow residue to be present after the water is dried from the cleaned object (staining or residue can cause water-spotting in some cases). One example of a cleaning operation is described in U.S. Pat. No. 6,276,015, entitled “Method of Cleaning a Soiled Surface”, the entirety of which is herein incorporated by reference. A RO system can be used to remove the metal ions or the materials that cause the staining or water-spotting.

As another example, in some operations where build-up of scale is an issue, the RO systems described above can be used to remove materials that cause the scaling. For example, in misting systems where water evaporation occurs readily, build-up of scale can be an issue. Removing the scaling materials from the water prior to the misting operation can lessen the amount of scaling that occurs. One example of such a system is described in U.S. Pat. No. 6,454,190, entitled “Water Mist Cooling System”, the entirety of which is herein incorporated by reference.

Yet another embodiment of the invention comprises a method of purifying fluid with an RO system. The RO system can have a RO module and a pumping system. The RO module can have a concentrate side and a purified side, separated by a RO membrane. The method includes the step of introducing feed fluid to a RO system. The pressure of the feed fluid can be boosted using a pumping system, where the pumping system can be any of the systems described above. The method can further comprise the step of exhausting a portion of the fluid from the concentrate side of the RO module, forming a recycle line. At least a portion of the exhausted concentrate can be introduced to the pumping system through the recycle line. The pumping system can be used to boost the pressure of both the feed fluid and the recycled concentrate to above an osmotic pressure, and these pressurized fluids can then be fed into the concentrate side of the RO module. In addition, the method can include the step of splitting off a portion of the concentrate exhaust into an effluent stream that can exit the system. A further step in the method includes recovering the energy of this effluent stream.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes may be made in details, particularly in matters of shape, size and arrangement of parts without exceeding the scope of the invention.

What is claimed is:

1. A reverse osmosis system comprising:
a reverse osmosis housing having an inlet port, a permeate exit port and a concentrate exit port;
a first pump having an inlet port and an outlet port;
a second pump having an inlet port and an outlet port;
the outlet port of the first pump fluidly coupled to the outlet port of the second pump, and further fluidly coupled to the inlet port of the reverse osmosis housing;
a recycle line fluidly coupled between the concentrate exit port of the reverse osmosis filter and the inlet port of the second pump; and
a feed fluid line coupled to the inlet port of the first pump.

2. The reverse osmosis system of claim 1, wherein;
the first pump includes a one-way valve in line with the inlet port of the first pump to help prevent fluid from escaping from the first pump through the inlet port of the first pump, and wherein the first pump includes a one-way valve in line with the outlet port of the first pump to help prevent fluid from entering the first pump through the outlet port of the first pump.

3. The reverse osmosis system of claim 2, wherein;
the second pump includes a one-way valve in line with the inlet port of the second pump to help prevent fluid from escaping from the second pump through the inlet port of the second pump, and wherein the second pump includes a one-way valve in line with the outlet port of the second pump to help prevent fluid from entering the second pump through the outlet port of the second pump.

4. The reverse osmosis system of claim 1, wherein the first pump and the second pump are provided in separate pump housings.

5. The reverse osmosis system of claim 1, wherein the first pump and the second pump are provided in a common pump housing.

6. The reverse osmosis system of claim 5, wherein the common pump housing includes an outlet mixing chamber that is in fluid communication with the outlet port of the first pump and the outlet port of the second pump, and is further in fluid communication with the inlet port of the reverse osmosis housing.

7. The reverse osmosis system of claim 6, wherein the common pump housing includes an inlet chamber, the inlet chamber is divided into a first inlet sub-chamber and a second inlet sub-chamber, wherein the first inlet sub-chamber is in fluid communication with the inlet port of the first pump and the feed fluid line, and the second inlet sub-chamber is in fluid communication with the inlet port of the second pump and the recycle line, the first inlet sub-chamber and the second inlet sub-chamber being separated by a wall of the common housing.

8. The reverse osmosis system of claim 7, wherein the common housing includes a pump body and a manifold, wherein the manifold is removably secured to the pump body, the pump body and the cover together defining the inlet sub-chambers, and the manifold having the wall that separates the first inlet sub-chamber from the second inlet sub-chamber.

9. The reverse osmosis system of claim 1, wherein the first pump and the second pump together form a double-acting simplex plunger pump, the first pump forming a first side of the double-acting simplex plunger pump and the second pump forming a second side of the double-acting simplex plunger pump.

10. The reverse osmosis system of claim 9, wherein the double-acting simplex plunger pump has a plunger with two ends, with each end acting in one of the sides of the pump.

11. The reverse osmosis system of claim 1, wherein the first pump and the second pump together form a duplex plunger pump, wherein a plunger is disposed in each of two pumping chambers.

12. The reverse osmosis system of claim 1, wherein the first pump is a positive displacement pump and the second pump is a positive displacement pump.

13. The reverse osmosis system of claim 1, further comprising a regulator having an inlet in fluid communication with the recycle line, and an outlet in fluid communication with an effluent line, wherein the regulator selectively bleeds off a portion of a concentrate traveling through the recycle line to the waste line.

14. The reverse osmosis system of claim 1, further comprising:
a bypass line extending between the feed fluid line and the recycle line;
a first valve in the bypass line and a second valve in the recycle line, wherein the relative positions of the first valve and the second valve can change the relative amounts of feed fluid and recycle concentrate that is provided to the inlet of the second pump.

15. The reverse osmosis system of claim 1, further including a pressure regulating bypass valve in the recycle line to bleed off a portion of the fluid in the recycle line.

16. The reverse osmosis system of claim 1, further including an energy recovery system adapted to covert fluid pressure generated by the first and/or second pump into mechanical and/or electrical energy.

17. A reverse osmosis system comprising:
a reverse osmosis filter with a membrane, an inlet port, a permeate exit port and a concentrate exit port;
a pump having a pump housing, the pump housing having a first pumping chamber and a second pumping chamber, each pumping chamber having an inlet port and an exit port;
a mixing chamber that is fluidly coupled to the exit port of the first pumping chamber through a first valve, and to the exit port of the second pumping chamber through a second valve;
a first fluid line fluidly connecting the mixing vessel to the inlet port of the reverse osmosis filter;
a recycle line for returning pressurized fluid from the concentrate exit port of the reverse osmosis filter to the inlet port of the second pumping chamber; and
a feed fluid line coupled to the inlet port of the first pumping chamber.

18. The reverse osmosis system of claim 17, wherein the pump is a positive displacement pump that raises the pressure of fluids in the first pump chamber and the second pump chamber to an operating pressure.

19. The reverse osmosis system of claim 17, wherein the pump is a double-acting simplex plunger pump.

20. The reverse osmosis system of claim 19, wherein the double-acting simplex plunger pump has a shaft with two ends with a plunger on each end of the shaft, wherein a plunger is disposed in each of the first and second pumping chambers.

21. The reverse osmosis system of claim 17, wherein the pump is a duplex plunger pump, wherein a plunger is disposed in each of the first and second pumping chambers.

22. The reverse osmosis system of claim 17, further comprising a regulator having an inlet port and an outlet port, wherein the inlet port of the regulator is in fluid communication with the recycle line and the outlet port of the regulator is in fluid communication with a waste line, wherein the regulator bleeds off a portion of the concentrate in the recycle line from the reverse osmosis filtering system through the waste line.

23. The reverse osmosis system of claim 17, further comprising:
a bypass line extending between the feed fluid line and the recycle line;
a first valve in the bypass line and a second valve in the recycle line, wherein the relative positions of the first valve and the second valve can change the relative amounts of feed fluid and recycle concentrate that is provided to the inlet of the second pumping chamber

24. The reverse osmosis system of claim 17, wherein the mixing chamber includes a length of piping.

25. The reverse osmosis system of claim 17, wherein the mixing chamber is a separate chamber defined by the pump housing.

26. The reverse osmosis system of claim 17, wherein the pump housing includes an inlet chamber, the inlet chamber is divided into a first inlet sub-chamber and a second inlet sub-chamber, wherein the first inlet sub-chamber is in fluid communication with the inlet port of the first pumping chamber and the feed fluid line, and the second inlet sub-chamber is in fluid communication with the inlet port of the second pumping chamber and the recycle line, the first inlet sub-chamber and the second inlet sub-chamber being separated by a wall of the pump housing.

27. The reverse osmosis system of claim 26, wherein the pump housing includes a pump body and a cover, wherein the cover is removably secured to the pump body, the pump body and the cover together defining the inlet chamber, and the cover having the wall the separates the first inlet sub-chamber from the second inlet sub-chamber.

28. The reverse osmosis system of claim 17, wherein the recycle line comprises an enclosed conduit such that at least a substantial portion of the pressure of the recycle stream as it exits the reverse osmosis filter is returned with the recycle stream to the second pumping chamber.

29. The reverse osmosis system of claim 17, further including a pressure regulating bypass valve in the recycle line to bleed off a portion of the fluid in the recycle line.

30. A method of filtering a fluid using a reverse osmosis filter and a first pump and a second pump, wherein the reverse osmosis filter includes an inlet, a permeate outlet and a concentrate outlet, and wherein the first pump and the second pump each include an inlet and an outlet, the method comprising:
providing feed fluid to the inlet of the first pump;
providing a recycle stream from the concentrate outlet of the reverse osmosis filter to the inlet of the second pump;
using the first pump to boost the feed fluid up to or near an operational pressure;
using the second pump to boost the recycle stream up to or near the operational pressure; and
after boosting the feed fluid and the recycle streams using the first and second pumps, mixing the boosted streams together and providing them to the inlet of the reverse osmosis filter.

31. The method of claim 30, wherein the pressure of the recycle stream exiting the concentrate outlet of the reverse osmosis filter is at least substantially maintained at the inlet of the second pump.

32. The method of claim 30, further comprising the step of bleeding off a portion of the recycle stream and exhausting the bleeded off portion.

33. The method of claim 30, further comprising the step of operating the first pump and the second pump at the same speed.

34. The method of claim 33, wherein the first pump and the second pump are mechanically coupled together to operate at the same speed.

35. The method of claim 34, wherein the first pump and the second pump are in a common housing.

36. The method of claim 34, wherein the first pump is at least partially assisted by the pressure of the recycle stream coming into the inlet of the second pump.
